(19) United States
(12) Patent Application Publication
(10) Pub. No.: US 2016/0241846 A1
(43) Pub. Date: Aug. 18, 2016

(54) METHOD AND DEVICE FOR PROCESSING IMAGE

(71) Applicant: SAMSUNG ELECTRONICS CO., LTD., Suwon-si (KR)

(72) Inventors: Seoyoung CHOI, Suwon-si (KR); Dong Kyung NAM, Suwon-si (KR); Yang Ho CHO, Suwon-si (KR); Jinho LEE, Suwon-si (KR)

(73) Assignee: Samsung Electronics Co., Ltd., Suwon-si (KR)

(21) Appl. No.: 15/027,195

(22) PCT Filed: Oct. 2, 2014
(86) PCT No.: PCT/KR2014/009305

§ 371 Date: Apr. 4, 2016

(30) Foreign Application Priority Data
Oct. 4, 2013 (KR) 10-2013-0118814

(51) Int. Cl. H04N 13/04

(52) U.S. Cl. CPC H04N 13/0445; H04N 13/0409; H04N 13/0472

(57) ABSTRACT

An image device generates a plurality of multi-view output images on the basis of an input image, and outputs the plurality of generated output images. The plurality of output images are outputted in a direction opposite to the views of the output images. The plurality of outputted output images are projected towards a left eye and a right eye of a viewer of the image device such that the viewer can recognize three-dimensional images.

### TECHNICAL FIELD

Example embodiments of the following description relate to image processing, and more particularly, to an image processing apparatus and method that generate a plurality of multi-view output images.

### RELATED ART

Methods for an imaging apparatus to provide a three-dimensional (3D) stereoscopic image to a viewer include a method using a stereo scheme based on binocular parallax, a method using a volumetric display that forms a stereoscopic image directly on a space, and a method using a holography display based on optical interference.

When the 3D stereoscopic image is provided to the viewer of the imaging apparatus by the stereoscopic scheme based on binocular parallax, output images having different views, generated by the imaging apparatus, are projected to a left eye and a right eye of the viewer of the imaging apparatus. The output images may be divided into images to be projected to the left eye and images to be projected to the right eye by 3D glasses the viewer is wearing.

Alternatively, the output images may be divided into images to be projected to the left eye and images to be projected to the right eye by an optical lens that may be disposed at a front side of a display panel of the imaging apparatus.

### DETAILED DESCRIPTION

### Solution

The foregoing and/or other aspects are achieved by providing an image processing method performed by an imaging apparatus, the method including generating a plurality of output images of multi-views based on a plurality of input images, and outputting the plurality of output images, wherein views of the plurality of output images are different from one another, and an order from a left to a right of regions to which the plurality of output images are projected in a space in which the plurality of output images are projected is opposite to an order from a left to a right of the views of the plurality of output images.

The plurality of output images may be projected in a continuous space.

The continuous space may be plural in number.

The plurality of output images may be projected to each of the plurality of continuous spaces in a same order.

The plurality of input images may include a left input image and a right input image.

The plurality of output images may include a leftmost view output image corresponding to the left input image and a rightmost view output image corresponding to the right input image.

The rightmost view output image may be projected to a leftmost side of the plurality of output images.

The leftmost view output image may be projected to a rightmost side of the plurality of output images.

A right view output image among the plurality of output images may be projected to a left eye of a viewer when the viewer is located in one of the plurality of continuous spaces.

A left view output image among the plurality of output images may be projected to a right eye of the viewer when the viewer is located in one of the plurality of continuous spaces.

The left view output image and the right view output image may be images having neighboring views among the plurality of output images.

A view of the left view output image may be located on a left side of a view of the right view output image.

The leftmost view output image may be projected to the left eye of the viewer when the viewer is located in two of the plurality of continuous spaces.

The rightmost view output image may be projected to the right eye of the viewer when the viewer is located in two of the plurality of continuous spaces.

A difference in views between two neighboring output images among the plurality of output images may be within 1 view.

A difference in views between the leftmost view output image and the rightmost view output image among the plurality of output images may be 1 view.

The plurality of output images may include at least three output images.

The plurality of input output images may include a left input image and a right input image.

The plurality of output images may include a leftmost view output image corresponding to the left input image, a rightmost view output image corresponding to the right input image, and an interpolated image.

The interpolated image may be generated based on interpolation between the left input image and the right input image.

The plurality of input images may include a left input image and a right input image.

The plurality of output images may include a leftmost view output image corresponding to the left input image, a rightmost view output image corresponding to the right input image, and an interpolated image.

The rightmost view output image may be projected to a leftmost side of the plurality of output images.

The leftmost view output image may be projected to a rightmost side of the plurality of output images.

The plurality of input images may include a left input image and a right input image.

A difference in views between the left input image and the right input image may be 1 view.

The 1 view may be determined based on an interpupillary distance (IPD) of a viewer, predicted with respect to the imaging apparatus.

A difference in views of two neighboring output images of the plurality of output images may be uniform.

The imaging apparatus may include a plurality of pixels.

Pixels corresponding to the plurality of output images may be neighboring pixels among the plurality of pixels.

The imaging apparatus may include a plurality of lenses.

Lights emitted by the neighboring pixels are projected through a lens disposed in front of the neighboring pixels among the plurality of lenses.

The lens may project the lights of the neighboring pixels in a direction opposite to a direction from a left to a right of the neighboring pixels.

The plurality of output images may be projected to each of the plurality of continuous spaces in a same order.

The lens may project the lights of the neighboring pixels to each of the plurality of continuous spaces.

The foregoing and/or other aspects are also achieved by providing an image processing apparatus including an image processor to generate a plurality of output images of multi-views based on a plurality of input images, and an image outputter to output the plurality of output images, views of the plurality of output images are different from one another, and an order from a left to a right of regions to which the plurality of output images are projected in a space in which the plurality of output images are projected is opposite to an order from a left to a right of the views of the plurality of output images.

The plurality of output images may be projected in a continuous space.

The continuous space may be plural.

The plurality of output images may be projected to each of the plurality of continuous spaces in a same order.

The plurality of input images may include a left input image and a right input image.

The plurality of output images may include a leftmost view output image corresponding to the left input image and a rightmost view output image corresponding to the right input image.

The rightmost view output image may be projected to a leftmost side of the plurality of output images.

The leftmost view output image may be projected to a rightmost side of the plurality of output images.

A right view output image among the plurality of output images may be projected to a left eye of a viewer.

A left view output image among the plurality of output images may be projected to a right eye of the viewer when the viewer is located in one of the plurality of continuous spaces.

The left view output image and the right view output image may be images having neighboring views among the plurality of output images.

A view of the left view output image may be on a left side of a view of the right view output image.

The leftmost view output image may be projected to the left eye of the viewer when the viewer is located in two of the plurality of continuous spaces.

The rightmost view output image may be projected to the right eye of the viewer when the viewer is located in two of the plurality of continuous spaces.

The image outputter may include a plurality of pixels.

Pixels corresponding to the plurality of output images may be neighboring pixels among the plurality of pixels.

The image outputter may further include a plurality of lenses.

Lights emitted by the neighboring pixels may be projected through a lens disposed in front of the neighboring pixels among the plurality of lenses.

The lens may project the lights of the neighboring pixels in a direction opposite to a direction from a left to a right of the neighboring pixels.

### BRIEF DESCRIPTION OF THE DRAWINGS

FIG. 1 illustrates an imaging apparatus according to example embodiments.

FIG. 2 illustrates an image processing method according to example embodiments.

FIG. 3 illustrates an output image generation method according to example embodiments.

FIG. 4 illustrates a plurality of output images projected to a predetermined space, according to example embodiments.

FIG. 5 illustrates a plurality of output images projected to a plurality of predetermined spaces, according to example embodiments.

FIG. 6 illustrates relationships between a plurality of output images projected to a predetermined space and a viewer, according to example embodiments.

FIG. 7 illustrates a plurality of output images projected to a plurality of predetermined spaces by a lens, according to example embodiments.

FIG. 8 illustrates view differences among a plurality of output images projected to a predetermined space, according to example embodiments.

### DETAILED DESCRIPTION

Hereinafter, example embodiments will be described with reference to the accompanying drawings. Reference numerals refer to like elements throughout.

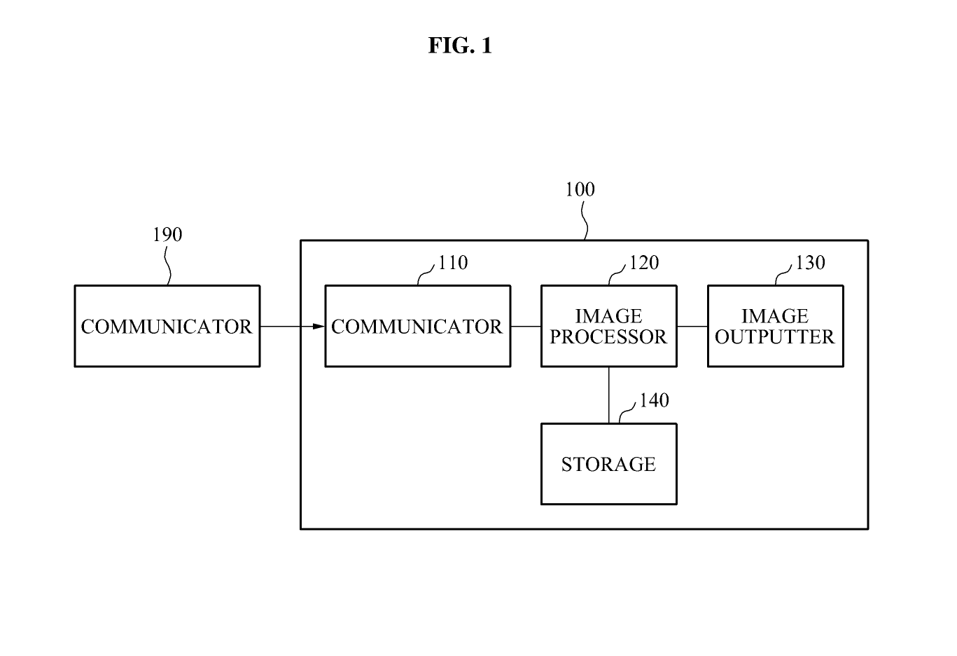

FIG. 1 illustrates an imaging apparatus 100 according to example embodiments.

In FIG. 1, the imaging apparatus 100 adapted to process an image based on an input image is shown.

The imaging apparatus 100 may include a communicator 110, an image processor 120, an image outputter 130, and a storage 140.

The imaging apparatus 100 may be adapted to process an input image and output an output image perceived as a three-dimensional (3D) stereoscopic to a viewer. As each of output images having different views is projected to a left eye and a right eye of the viewer, the viewer may perceive an image output from the imaging apparatus 100 as the 3D stereoscopic image without 3D glasses. For example, the imaging apparatus 100 may be a non-glasses 3D display device such as a 3D television (TV), a mobile phone, and a 3D monitor, or a 3D stereoscopic image generation device included in the 3D TV, the mobile phone, and the 3D monitor.

The imaging apparatus 100 may be a multi-view 3D display device. The multi-view 3D display device may have a relatively wider viewing range, by which the viewer of the imaging apparatus 100 perceives the 3D stereoscopic image, than a viewing range of a 2-view 3D display device. That is, the viewer of the multi-view 3D display device may perceive the 3D stereoscopic image in a wider range than the viewer of the 2-view 3D display device.

The viewer of the imaging apparatus 100 may perceive the 3D stereoscopic image at a predetermined proper viewing distance from the imaging apparatus 100. The predetermined proper viewing distance may be determined according to functions and characteristics of components of the imaging apparatus 100. The predetermined proper viewing distance may be a distance between the imaging apparatus 100 and the viewer of the imaging apparatus 100, the distance at which the output image of the imaging apparatus 100 may be most clearly seen as the 3D stereoscopic image to the viewer. That is, when the distance between the imaging apparatus 100 and the viewer is the predetermined proper viewing distance, the output images having different views may be accurately projected to the left eye and the right eye of the viewer.

A communicator 190 may be a device separated from the imaging apparatus 100. The communicator 190 may be a device adapted to transmit an input image to the imaging apparatus 100 through a wired or wireless communication line.

As the input image input from the communicator 190 is processed and output by the imaging apparatus 100, the viewer of the imaging apparatus 100 may perceive the 3D stereoscopic image. The input image input to the communicator 190 may be an image processed by the imaging apparatus 100. The input image may be an image used for generation of the output image. The communicator 190 may be a part of a stereo camera system, which is adapted to transmit a 2-view image taken by the stereo camera to the imaging apparatus 100.

The input image may be a 2-view image taken by the stereo camera. The input image may be data formed by compressing or encoding a 2-view image.

The communicator 110 may receive the input image from the communicator 190 through a wired or wireless communication line. The communicator 110 may transmit the received input image to the image processor 120. Alternatively, the communicator 110 may store the received input image in the storage 140.

The communicator 110 may be a hardware module such as a network interface card, a network interface chip, and a network interface port.

The image processor 120 may be adapted to process calculation necessary for generation of the plurality of output images having different views based on the input image. For example, when the input image is encoded data, the image processor 120 may perform decoding of the input image. The image processor 120 may include at least one processor for processing calculation necessary for generation of the plurality of output images. For example, the image processor 120 may include a graphics processing unit (GPU).

The image processor 120 may generate a plurality of output images of multi-views. The input image may be an image received from the communicator 190 described above or an image stored in the storage 140 that will be described later. The input image may be a 2-view image or a 2D image including depth information.

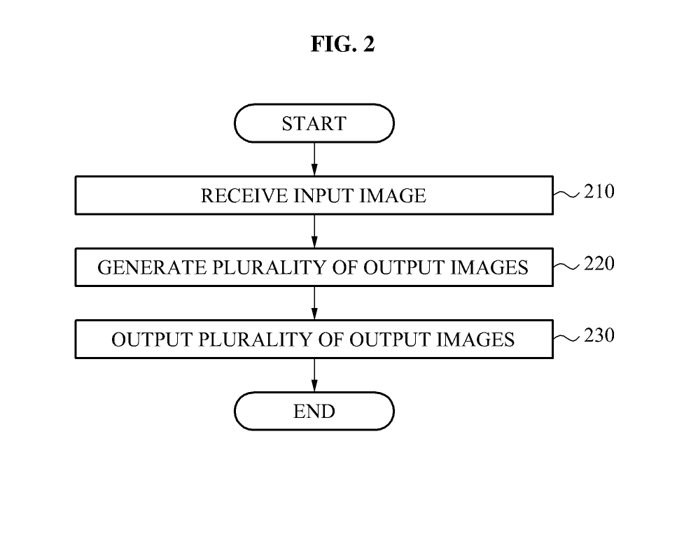

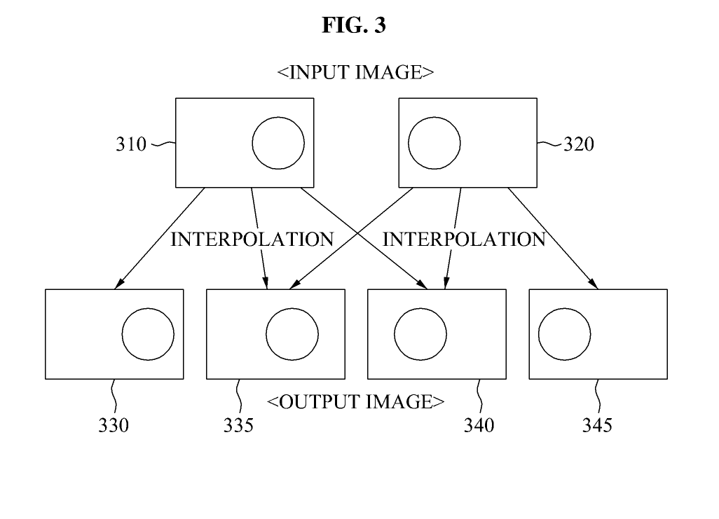

A method of generating the output images having different views from the input image will be described in detail with reference to FIGS. 2 and 3.

The storage 140 may store at least one of information related to setting and operation of the imaging apparatus 100 and the input image. The input image stored in the storage 140 may be an image transmitted from the communicator 190 or an image transmitted from an external electronic device or electronic medium other than the communicator 190. For example, the input image stored in the storage 140 may include depth information.

The storage 140 may be a hardware module for storing information, such as a hard disc drive (HDD), a solid stage drive (SSD), and a flash memory.

The image outputter 130 may be adapted to output the output image generated by the image processor 120, and to project the output image to a space in which the viewer of the imaging apparatus 100 may perceive the 3D stereoscopic image.

Although not shown, the image outputter 130 may include a display panel. The display panel of the image outputter 130 may include a plurality of pixels. For example, the image outputter 130 may be a liquid crystal display (LC), a plasma display panel (PDP), or an organic light emitting diode (OLED) display.

The output image generated by the image processor 120 may be output by being assigned to the pixels of the image outputter 130. The output image output by the image outputter 130 may be projected to the left eye and the right eye of the viewer located at the predetermined proper viewing distance from the image outputter 130.

A method related to output of the output image generated by the image processor 120 by the image outputter 130 and projection of the output image generated by the image processor 120 to the space will be described in further detail with reference to FIGS. 2 to 8.

FIG. 2 illustrates an image processing method according to example embodiments.

According to the above description related to FIG. 1, the image processor 120 generates the plurality of output images of multi-views based on the input image, and the image outputter 130 outputs the plurality of output images generated by the image processor 120.

In operation 210, the communicator 110 may receive a plurality of input images. The plurality of input images may be a plurality of images having different views from one another. The plurality of input images may include a left input image which is an image having a left view and a right input image which is an image having a right view in comparison to the left input image.

The left input image may further include leftmost information not included in the right input image. That is, information included in the left input image may correspond to visual information recognized by a left eye of a viewer. The right input image may further include rightmost information not included in the left input image. That is, information included in the right input image may correspond to visual information recognized by a right eye of a viewer. For example, the left input image and the right input image may be images taken by lenses of a stereo camera.

In operation 220, the image processor 120 may generate the plurality of output images of the multi-views based on the plurality of input images. That is, each of the plurality of output images may be generated from the plurality of input images including the left input image and the right input image.

The views of the plurality of output images generated by the image processor 120 may be different from one another. For example, the plurality of output images may include a leftmost view output image corresponding to the left input image that includes the leftmost information and a rightmost view output image corresponding to the right input image that includes the rightmost information among the plurality of input images.

A number of the plurality of output images generated by the image processor 120 may be different from a number of the plurality of input images. For example, the number of the output images may be larger than the number of the input images. The plurality of input images may be images taken through the lenses of the stereo camera. When the number of the plurality of input images is two, the plurality of output images may include at least one middle view output image having different view, in addition to the leftmost view output image and the rightmost view output image.

The middle view output images may further include information of a right side of the leftmost view output image view and information of a left side of the rightmost view output image. For example, the plurality of output images generated by the image processor 120 may include at least three output images. In this case, two of the plurality of output images may be the leftmost view output image and the rightmost view output image.

A method of generating the plurality of output images of multi-views from the plurality of input images will be described in further detail with reference to FIG. 3.

In operation 230, the image outputter 130 may output the plurality of output images generated by the image processor 120. The plurality of output images may be output from different positions on the display panel of the image outputter 130. The positions on the display panel, from which the plurality of output images are output, may be the pixels of the display panel, each of which is allocated with each of the output images. The plurality of output images may be output from neighboring pixels of the display panel. The pixels corresponding to the plurality of output images may be neighboring pixels among the plurality of pixels of the display panel. The pixels corresponding to the plurality of output images may be pixels from which the plurality of output images are output, among the plurality of pixels of the image outputter 130. For example, the output images may be output from each of the neighboring pixels of the display panel of the image outputter 130 in the order of views from the leftmost view output image to the rightmost view output image.

The output images output from the pixels of the image outputter 130 may be lights that include information related to the output images. For example, the information on the output images included in the lights output from the pixels may be color information, such as red (R), green (G), and blue (B) values, of the output images.

The plurality of output images generated by the image processor 120 may be projected in a continuous space. Regions to which the plurality of output images are not projected may be present between respective regions to which the plurality of output images are projected within a predetermined space to which the plurality of output images are projected. That is, the plurality of output images may be projected without generating gaps or such that only a gap not perceivable by the viewer is generated within the predetermined space.

The regions to which the plurality of output images are projected within the predetermined space may be different from one another. That is, there may be no region in which at least two output images are redundantly projected within the predetermined space to which the plurality of output images are projected.

When the plurality of output images generated by the image processor 120 are projected to a predetermined space located on a plane distanced by the predetermined proper viewing distance from the imaging apparatus 100, the plurality of output images may be projected in the continuous space. The regions to which the plurality of output images are projected in the predetermined space may be different from one another. In this case, the viewer of the imaging apparatus 100 located in the predetermined space may perceive the output images in every region of the predetermined space. Only one output image of the plurality of output images may be projected to the left eye and the right eye of the viewer.

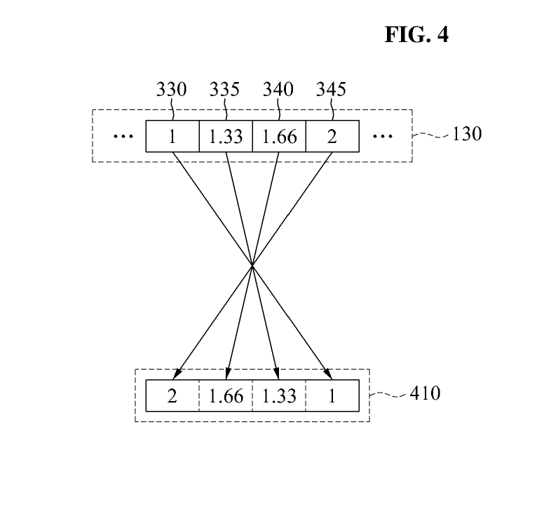

A method related to projection of the plurality of output images generated by the image processor 120 to the space will be described in further detail with reference to FIGS. 4 to 8.

Since the technical features above described with reference to FIGS. 1 and 2 may be directly applied, a detailed description will be omitted.

FIG. 3 illustrates an output image generation method according to example embodiments.

FIG. 3 shows a case in which the plurality of output images are generated by the plurality of input images including a left input image 310 and a right input image 320 described with reference to FIG. 2. Position differences of circles marked in images 310 to 345 may indicate view differences of the images 310 to 345.

The left input image 310 and the right input image 320 may be images taken by the stereo camera, that is, input images stored in the storage 140 of FIG. 1 or images transmitted from the communicator 190 to the imaging apparatus 100.

The input images 310 and 320 may include predetermined depth information indicating a sense of depth of an object expressed in the input images 310 and 320. For example, when only the left input image 310 is projected to the left eye and the right eye of the viewer of the imaging apparatus 100, the viewer may feel a stereoscopic feeling with respect to the object expressed in the left input image 310 through predetermined depth information of the left input image 310 based on experiential perception. The predetermined depth information expressing the sense of depth of the object expressed in the input images 310 and 320 may include at least one of shape information, size information, distance information, occlusion information, and lighting information of the object.

A view difference between the left input image 310 and the right input image 320 may be 1 view. The view difference between the left input image 310 and the right input image 320 may be determined based on an interpupillary distance (IPD) of the viewer of the imaging apparatus 100, predicted with respect to the imaging apparatus 100. For example, when the view difference between images is 1 view, 1 view may be equivalent to 1 IPD. 1 IPD may be determined based on an IPD of a general person. That is, a view difference between visual information perceived by a left eye of the general person and visual information perceived by a right eye may be 1 IPD. 1 IPD may correspond to a distance between two lenses of the stereo camera.

When the left input image 310 is projected to the left eye and the right input image 320 is projected to the right eye, and when the view difference between the left input image 310 and the right input image 320 is 1 IPD, the viewer of the imaging apparatus 100 may perceive input images projected to both eyes as a stereoscopic image.

The images 330 to 350, as output images generated from the left input image 310 and the right input image 320, may include a leftmost view output image 330, a first middle view output image 335, a second middle view output image 340, and a rightmost view output image 345.

The leftmost view output image 330 may correspond to the left input image 310. That is, information included in the leftmost view output image 330 may correspond to the visual information perceived by a left eye of a viewer. The rightmost view output image 345 may correspond to the right output image 320. That is, information included in the rightmost view output image 345 may correspond to visual information perceived by a right eye of a viewer.

Each of the middle view output images may further include information of a right side of the leftmost view output image and information of a left side of the rightmost view output image. That is, each of the middle view output images may be output images of views present between a leftmost view and a rightmost view among the plurality of output images.

The plurality of output images 330 to 345 generated from the input images 310 and 320 may include the leftmost view output image 330 corresponding to the left input image 310, the rightmost view output image 345 corresponding to the right input image 320, and an interpolated image of the plurality of input images 310 and 320. The interpolated image may be generated based on interpolation between the left input image 310 and the right input image 320. The interpolated image may be generated as at least one image of different views. For example, the first middle view output image 335 and the second middle view output image 340 may be the interpolated images generated based on interpolation between the left input image 310 and the right input image 320.

The interpolation between the left input image 310 and the right input image 320 may refer to generation of middle view images present between the view of the left input image 310 and the view of the right input image 320, using information included in the left input image 310 and the right input image 320. The image processor 120 may generate the interpolated image by applying an image interpolation method to the left input image 310 and the right input image 320. The image interpolation method may apply at least one generally known algorithm used for image interpolation.

The plurality of output images 330 to 345 may include predetermined depth information included in the input images 310 and 320.

Each of the plurality of output images 330 to 345 may be projected to different regions of the predetermined space described with reference to FIG. 2 by the image outputter 130. For example, each of the plurality of output images 330 to 345 may be projected to each of four regions evenly divided from a predetermined space from a leftmost region to a rightmost region.

A method of projecting the plurality of output images 330 to 345 to the predetermined space will be described in detail with reference to FIGS. 4 to 8.

Although FIG. 4 shows only a case in which four input images are generated from two input images, the foregoing description may also be applied when at least five output images are generated from at least one input image. When a plurality of output images are generated from one input image, the input image may include additional information for generation of the plurality of output images, for example, depth information.

When an N-number of output images are generated by the image processor 120, the imaging apparatus 100 may be an N-view non-glasses 3D display device. For example, when four input images 330 to 345 are generated by the image processor 120, the imaging apparatus 100 may be a four-view non-glasses 3D display device.

Since the technical features described with reference to FIGS. 1 and 2 may be directly applied, a detailed description will be omitted.

FIG. 4 illustrates a plurality of output images projected to a predetermined space, according to example embodiments.

In a case of FIG. 4, the plurality of output images 330 to 345 output by the image outputter 130 are projected to different regions of a continuous space 410. The plurality of output images 330 to 345 may be projected in the continuous space 410.

The continuous space 410 may be located on a plane distance by the predetermined proper viewing distance from the imaging apparatus 100 as described with reference to FIG. 2.

Values of from 1 to 2 marked in the plurality of output images 330 to 345 may be relative values for distinguishing the view difference among the plurality of output images 330 to 345. For example, a value 1 marked in the leftmost view output image 330 may indicate a leftmost view image. As a number marked in the output image is larger, the output image may have a more right view. A value marked in the rightmost view output image 345 may be 2. A view difference between the leftmost view output image 330 and the rightmost view output image 345 is 1. That is, the view difference between the leftmost view output image 330 and the rightmost view output image 345 is 1 IPD.

Therefore, the view difference between the leftmost view output image 330 and the rightmost view output image 345 among the plurality of output images 330 to 345 may be 1. A view difference between two neighboring output images among the plurality of output images 330 to 345 may be within 1 view. Out of views of the plurality of output images 330 to 345, view differences between two neighboring output images may be uniform. For example, as illustrated, the view difference between neighboring images among the plurality of output images 330 to 345 may be uniform. However, in a case of FIG. 4, digits after a second decimal place are truncated for convenience. Alternatively, the image processor 120 may control the view difference between two neighboring output images among the plurality of output images 330 to 345. For example, when generating the interpolated images, the image processor 120 may control the view difference between the two neighboring output images by adjusting variables used for the image interpolation method applied to the left input image 310 and the right input image 320.

An order from the left side to the right side of the regions to which the plurality of output images 330 to 345 are projected in the continuous space 410 in which the plurality of output images 330 to 345 are projected may be opposite to an order from the left side to the right side of the views of the plurality of output images 330 to 345. For example, as illustrated, the plurality of output images 330 to 345 may be output in the order from the left side to the right side of the views of the plurality of output images 330 to 345 to neighboring pixels of the image outputter 130, in the order from the left side to the right side of the pixels. The plurality of output images 330 to 345 may be projected to from the leftmost region to the right side of the four evenly divided regions of the continuous region 410 which is continuous from the right side to the left side of the views of the plurality of output images 330 to 345. The four evenly divided regions may have equal sizes. A width of each of the four evenly divided regions may be 1 IPD or less. That is, each region of the continuous space 410 that the plurality of output images 330 to 345 reach may have a width of 1 IPD or less.

For example, the rightmost view output image 345 out of the plurality of output images 330 to 345 may be projected to the leftmost region of the continuous space 410. In addition, the leftmost view output image 330 may be projected to the rightmost region of the continuous space 410. As illustrates, the second middle view output image 340, which is a more right image between the first middle view output image 335 and the second middle view output image 340, may be projected to a region neighboring a right side of the region to which the rightmost view output image 345 is projected in the continuous space 410. The first middle view output image 335 may be projected to a region neighboring a left side of the region to which the leftmost view output image 330 is projected in the continuous space 410.

Since the foregoing technical features of FIGS. 1 to 3 may be directly applied, a detailed description will be omitted.

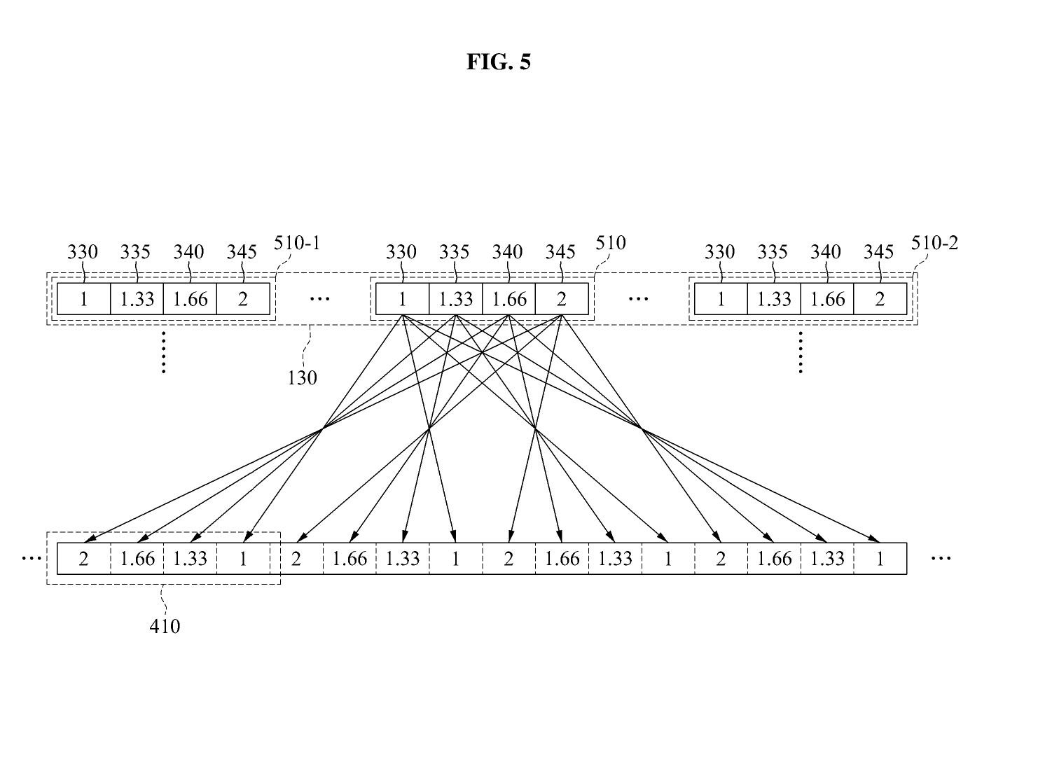

FIG. 5 illustrates a plurality of output images projected to a plurality of predetermined spaces, according to example embodiments.

The continuous space 410 to which the plurality of output images 330 to 345 are projected may be plural. The plurality of output images 330 to 345 may be projected to each of the plurality of continuous spaces in a same order as when projected to the continuous space 410.

A set 510 of the neighboring pixels of the image outputter 130 outputting the plurality of output images 330 to 345 may be plural. The plurality of output images 330 to 345 may be output in each pixel of the plurality of sets 510, 510-1, and 510-2, in a same order as when output in pixels of the set 510. The sets 510, 510-1, and 510-2 may be present in continuous positions on the image outputter 130.

Although not illustrated in FIG. 5 for convenience, the plurality of output images 330 to 345 output from the sets 510, 510-1, and 510-2 of the plurality of pixels may be projected to each of the continuous spaces in the same as when projected to the continuous space 410.

According to an increase in number of the sets 510, a number of the continuous spaces 410 may be increased. The continuous space 410 may be a viewing range by which the viewer of the imaging apparatus 100 may perceive the 3D stereoscopic image. That is, according to an increase in the number of the sets 510, the viewing range by which the viewer may perceive the 3D stereoscopic image may be increased.

Although FIG. 5 shows the sets arranged in only a lateral direction of the image outputter 130, the sets may be arranged in a longitudinal direction of the image outputter 130.

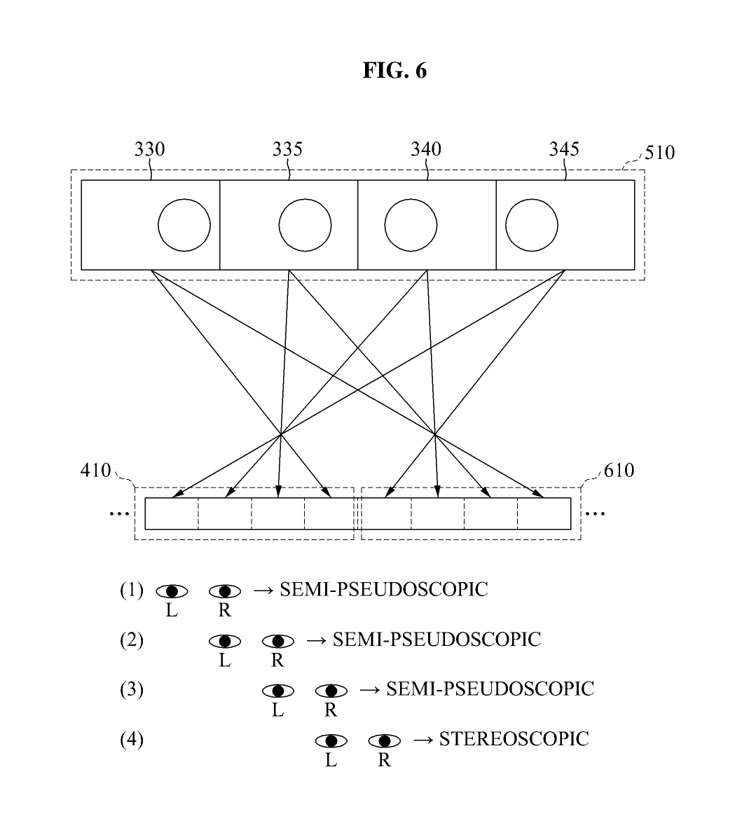

Perceiving of the 3D stereoscopic image of the plurality of output images 330 to 345 projected to the plurality of continuous spaces in the continuous space 410 by the viewer will be described in further details, with reference to FIG. 6.

Since the foregoing technical features of FIGS. 1 to 4 may be directly applied, a detailed description will be omitted.

FIG. 6 illustrates relationships between a plurality of output images projected to a predetermined space and a viewer, according to example embodiments.

The left eye and the right eye of the viewer of the imaging apparatus 100 may be located in the plurality of continuous spaces described with reference to FIG. 5. For example, continuous spaces 410 and 610 may correspond to the plurality of continuous spaces of FIG. 5. The continuous space 610 may be a space equivalent to the continuous space 410 and neighboring the continuous space 410.

Since the left eye and the right eye of the viewer are located in the plurality of spaces present on the plane distanced by the predetermined proper viewing distance from the imaging apparatus 100, different output images among the plurality of output images 330 to 345 may be projected to the left eye and the right eye, respectively. That is, the continuous spaces 410 and 610 may be the viewing range of the viewer.

Although the plurality of output images are output as a whole to the pixels of the set 510 in FIG. 6, information corresponding to only a part of the image may be output to the pixels of the set 510.

When the leftmost view output image 330 is projected to the left eye of the viewer and the rightmost view output image 345 is projected to the right eye of the viewer, a stereoscopic image is provided to the viewer. The viewer may perceive output images of the stereoscopic image projected to both eyes as the 3D stereoscopic image. Conversely, when the rightmost view output image 345 is projected to the left eye of the viewer and the leftmost view output image 330 is projected to the right eye of the viewer, a pseudoscopic image may be provided to the viewer. The viewer may not perceive output images of the pseudoscopic image as the 3D stereoscopic image. In case of the pseudoscopic image, view differences between the output images projected to both eyes of the viewer may be totally inverted from the views differences of the stereoscopic image. Therefore, a stereoscopic feeling opposite to the stereoscopic feeling based on the experiential perception of the viewer may be obtained. The viewer may not perceive the input images of the pseudoscopic image projected to both eyes as the 3D stereoscopic image and may feel fatigue when viewing the input images of the pseudoscopic image.

When the right view output image is projected to the left eye and the left view output image is projected to the right eye, when a view of the left view output image is a more left view than a view of the right view output image, and when the view difference between the left view output image and the right view output image is less than 1 view, a semi-pseudoscopic image may be provided to the viewer. The viewer may perceive output images of the semi-pseudoscopic image as the 3D stereoscopic image. The viewer of the imaging apparatus 100 may perceive the output images of the semi-pseudoscopic image projected to both eyes as the 3D stereoscopic image through predetermined depth information included in the aforementioned output images of FIG. 3. The output images of the semi-pseudoscopic image may be similar to the output images of the pseudoscopic image. Since the view difference between the output images projected to both eyes of the viewer is less than 1 view, the viewer may feel the stereoscopic feeling with respect to an object expressed in the output images through the predetermined depth information included in the output images of the semi-pseudoscopic image, based on the experiential perception. For example, the viewer may perceive a bright part of the object expressed in the object projected to both eyes as a prominent part, based on occlusion information and lighting information included in the output images. Also, the viewer may perceive a dark part of the object as a depressed part.

As shown in (1) to (3) of FIG. 6, when the left eye and the right eye of the viewer are located in the continuous space 410 between the plurality of continuous spaces 410 and 610, the right view output image may be projected to the left eye of the viewer and the left view output image may be projected to the right eye of the viewer among the plurality of output images 330 to 345. The left view output image and the right view output image may be images having neighboring views among the plurality of output images 330 to 345. The view of the left view output image may be a more left view than the view of the right view output image. The view difference between the left view output image and the right view output image projected to both eyes of the viewer may be less than 1 view. The view difference between the left view output image and the right view output image may be semi-pseudoscopic. That is, when the viewer is located in the continuous space 410, the semi-pseudoscopic image may be provided to the viewer. The view difference between the left view output image and the right view output image may be uniform.

As shown in (4) of FIG. 6, when the viewer of the imaging apparatus 100 is located in two of the continuous spaces 410 and 610, the leftmost view output image 330 is projected to the left eye and the rightmost view output image 345 is projected to the right eye of the viewer. The view difference between the leftmost view output image 330 and the rightmost view output image 345 may be 1 view. The view difference between the leftmost view output image 330 and the rightmost view output image 345 may be stereoscopic. That is, the stereoscopic image may be provided to the viewer when the viewer is located in two of the continuous spaces 410 and 610.

Since the view difference between the views of the images projected to both eye of the viewer in every possible position in the continuous spaces 410 and 610 is semi-pseudoscopic or stereoscopic, the viewer may perceive the output images projected to both eyes in every position of the continuous spaces 410 and 610 as the 3D stereoscopic image. That is, the semi-pseudoscopic image or stereoscopic image having a view difference of 1 view may be provided to the viewer in the viewing range of the imaging apparatus 100.

The 3D stereoscopic images perceived by the viewer in (1) to (4) may be based on two neighboring output images among the plurality of output images 330 to 345 or based on the leftmost view output image 330 and the rightmost view output image 345 among the plurality of output images 330 to 345. Accordingly, the 3D stereoscopic images may be different from one another.

Since technical features described with reference to FIGS. 1 to 4 may be directly applied, a detailed description will be omitted.

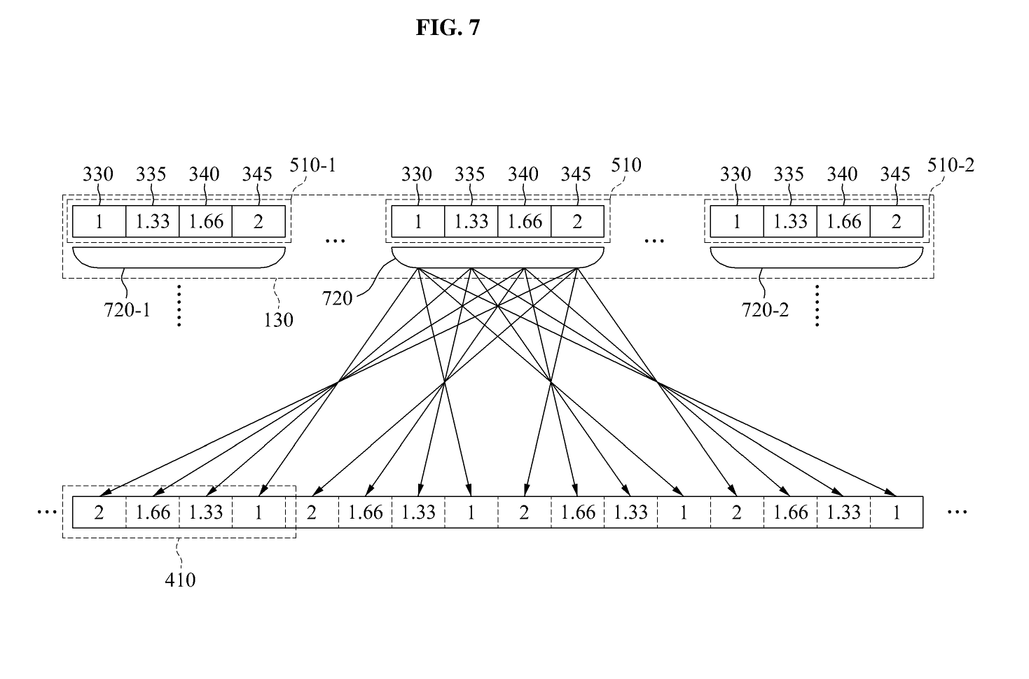

FIG. 7 illustrates a plurality of output images projected to a plurality of predetermined spaces by a lens, according to example embodiments.

The imaging apparatus 100 may include a plurality of lenses 720, 720-1, and 720-2. The plurality of lenses 720, 720-1, and 720-2 may be included in the image outputter 130. The plurality of lenses 720, 720-1, and 720-2 may be a set of lenses arranged in a lateral direction of the image outputter 130, that is, a lens array. The lens array may be arranged also in a longitudinal direction of the image outputter 130.

In FIG. 7, the plurality of output images 330 to 345 output from the set 510 of the pixels of FIG. 5 are projected to the plurality of continuous spaces by a lens 720. Although the plurality of output images 330 to 345 are shown as if being emitted from the lens 720 and projected to the continuous space 410 in FIG. 7, the plurality of output images 330 to 345 may be projected to the plurality of continuous spaces as the lights are emitted from the pixels of the set 510 and the emitted lights are refracted by passing through the lens 720.

In addition, although FIG. 7 shows four continuous spaces as the plurality of the continuous spaces, the number of the continuous spaces may be increased according to the number of the sets 510, 510-1, and 510-2.

The number of the sets 510, 510-1, and 510-2 may be equal to the number of the lenses.

The plurality of output images 330 to 345 output from the set 510 may be lights including information related to the output images 330 to 345. For example, the information of the output images 330 to 345 included in the lights emitted from the pixels of the set 510 may be color information, such as RGB values, of the output images 330 to 345.

The lights emitted from neighboring pixels of the set 510 may be projected through the lens 720 disposed in front of the neighboring pixels among the plurality of lenses 720, 720-1, and 720-2. The plurality of lenses 720, 720-1, and 720-2 may refract the lights emitted from the set 510 and project the lights to the plurality of continuous spaces.

The lens 720 may project the lights of the neighboring pixels of the set 510 in an opposite direction to a direction from the left side to the right side of the neighboring pixels. The lens 720 may project the lights of the neighboring pixels of the set 510 to each of the plurality of continuous spaces.

The plurality of lenses may be made of a plastic material.

For example, the plurality of lenses 720, 720-1, and 720-2 may be lenticular lenses. The lens 720 may have characteristic of a convex lens.

Different from as shown in the drawing, each of the plurality of lenses may correspond to each of the pixels of the image outputter 130. Therefore, the number of the pixels of the image outputter 130 may be equal to number of the plurality of lenses. In this case, the plurality of lenses may each have a hemispherical shape.

Alternatively, each of the plurality of lenses may have a semicylinder shape extending in the longitudinal direction of the image outputter 130. The number of the plurality of lenses may be equal to the number of the sets 510, 510-1, and 510-2 arranged in the lateral direction of the image outputter 130 or to the number of pixels arranged in the lateral direction of the image outputter 130. The plurality of semicylinder lenses may be arranged in a diagonal direction other than the longitudinal direction of the image outputter 130.

The plurality of lenses may be provided in the form of a sheet or film in a size corresponding to the image outputter 130. The sheet or film including the plurality of lenses may be attached to a front of the display panel of the image outputter 130.

Each of the plurality of lenses may be an electro-active lenticular lens, which is an electronic liquid crystal lens of which a refraction index is varied by a voltage applied to molecules of electronic liquid crystal. When each of the plurality of lenses of the imaging apparatus 100 is the electro-active lenticular lens, the viewer of the imaging apparatus 100 may view both the 3D stereoscopic image and a 2D image according to the applied voltage.

Since the technical features described with reference to FIGS. 1 to 6 may be directly applied, a detailed description will be omitted.

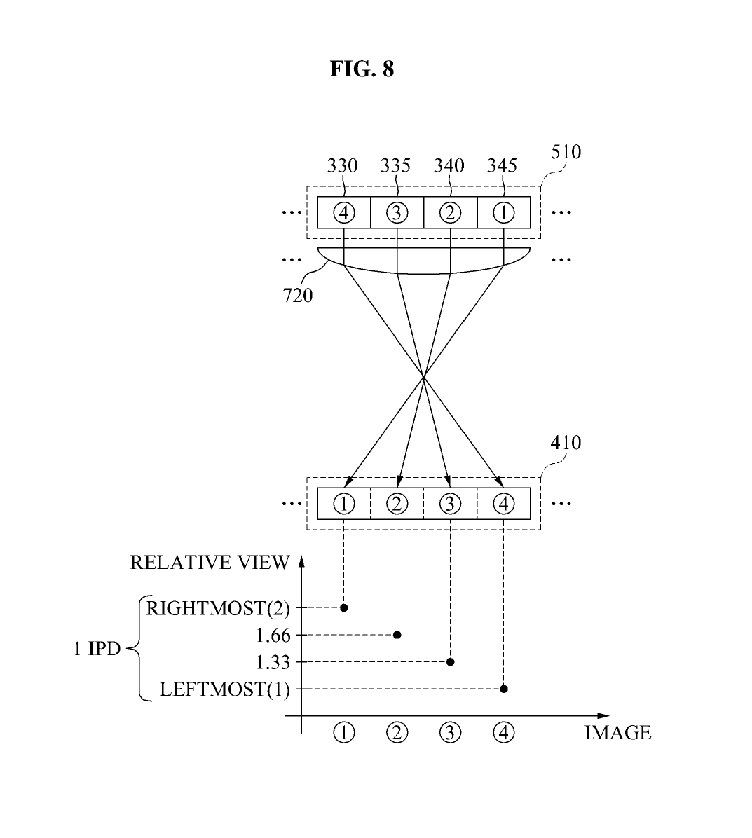

FIG. 8 illustrates view differences among a plurality of output images projected to a predetermined space, according to example embodiments.

As described with reference to FIG. 4, the values of from 1 to 2 corresponding to the plurality of images 330 to 345 may be relative values for distinguishing the view differences among the plurality of output images 330 to 345.

The plurality of output images 330 to 345 output from the set 510 may be projected by the lens 720 to each of the four regions evenly divided from the continuous space 410.

In the continuous space 410 in which the plurality of output images 330 to 345 are projected, the order from the left side to the right side of the regions to which the plurality of output images 330 to 345 are projected may be opposite to the order from the left side to the right side of the views of the plurality of output images 330 to 345.

As illustrated, the plurality of output images 330 to 345 may be projected from the leftmost side to the right of the four evenly divided regions of the continuous space 410, in the order of the views from the rightmost view output image 345 to the leftmost view output image 330.

The view differences among the neighboring output images of the plurality of output images 330 to 345 may be uniform. For example, the view difference may be about ⅓ IPD. The view difference between the rightmost view output image 345 and the leftmost view output image 330 may be about 1 IPD.

Since the technical features described with reference to FIGS. 1 to 7 may be directly applied, a detailed description will be omitted.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An image processing method performed by an imaging apparatus, the method comprising:
generating a plurality of output images of multi-views based on a plurality of input images; and
outputting the plurality of output images,
wherein views of the plurality of output images are different from one another, and
an order from a left to a right of regions to which the plurality of output images are projected in a space in which the plurality of output images are projected is opposite to an order from a left to a right of the views of the plurality of output images.

2. The image processing method of claim 1, wherein the plurality of output images are projected in a continuous space.

3. The image processing method of claim 2, wherein
the continuous space is plural in number, and
the plurality of output images are projected to each of the plurality of continuous spaces in a same order.

4. The image processing method of claim 3, wherein
the plurality of input images comprise a left input image and a right input image,
the plurality of output images comprise a leftmost view output image corresponding to the left input image and a rightmost view output image corresponding to the right input image,
the rightmost view output image is projected to a leftmost side of the plurality of output images whereas the leftmost view output image is projected to a rightmost side of the plurality of output images,
a right view output image among the plurality of output images is projected to a left eye of a viewer and a left view output image among the plurality of output images is projected to a right eye of the viewer when the viewer is located in one of the plurality of continuous spaces, the left view output image and the right view output image are images having neighboring views among the plurality of output images, a view of the left view output image is located on a left side of a view of the right view output image, and
the leftmost view output image is projected to the left eye of the viewer and the rightmost view output image is projected to the right eye of the viewer when the viewer is located in two of the plurality of continuous spaces.

5. The image processing method of claim 1, wherein
a difference in views between two neighboring output images among the plurality of output images is within 1 view, and
a difference in views between the leftmost view output image and the rightmost view output image among the plurality of output images is 1 view.

6. The image processing method of claim 1, wherein the plurality of output images comprise at least three output images.

7. The image processing method of claim 1, wherein
the plurality of input output images comprise a left input image and a right input image,
the plurality of output images comprise a leftmost view output image corresponding to the left input image, a rightmost view output image corresponding to the right input image, and an interpolated image, and
the interpolated image is generated based on interpolation between the left input image and the right input image.

8. The image processing method of claim 1, wherein
the plurality of input images comprise a left input image and a right input image,
the plurality of output images comprise a leftmost view output image corresponding to the left input image, a rightmost view output image corresponding to the right input image, and an interpolated image, and
the rightmost view output image is projected to a leftmost side of the plurality of output images and the leftmost view output image is projected to a rightmost side of the plurality of output images.

9. The image processing method of claim 1, wherein
the plurality of input images comprise a left input image and a right input image, and
a difference in views between the left input image and the right input image is 1 view.

10. The image processing method of claim 9, wherein the 1 view is determined based on an interpupillary distance (IPD) of a viewer, predicted with respect to the imaging apparatus.

11. The image processing method of claim 1, wherein a difference in views of two neighboring output images of the plurality of output images is uniform.

12. The image processing method of claim 1, wherein
the imaging apparatus comprises a plurality of pixels, and
pixels corresponding to the plurality of output images are neighboring pixels among the plurality of pixels.

13. The image processing method of claim 12, wherein
the imaging apparatus comprises a plurality of lenses,
lights emitted by the neighboring pixels are projected through a lens disposed in front of the neighboring pixels among the plurality of lenses, and
the lens projects the lights of the neighboring pixels in a direction opposite to a direction from a left to a right of the neighboring pixels.

14. The image processing method of claim 13, wherein the plurality of output images are projected to each of the plurality of continuous spaces in a same order, and
the lens projects the lights of the neighboring pixels to each of the plurality of continuous spaces.

15. A non-transitory computer-readable medium comprising a program for instructing a computer to perform the method according to one of claim 1.

16. An image processing apparatus comprising:
an image processor to generate a plurality of output images of multi-views based on a plurality of input images; and
an image outputter to output the plurality of output images,
views of the plurality of output images are different from one another, and
an order from a left to a right of regions to which the plurality of output images are projected in a space in which the plurality of output images are projected is opposite to an order from a left to a right of the views of the plurality of output images.

17. The image processing apparatus of claim 16, wherein
the plurality of output images are projected in a continuous space,
the continuous space is plural, and
the plurality of output images are projected to each of the plurality of continuous spaces in a same order.

18. The image processing apparatus of claim 17, wherein
the plurality of input images comprise a left input image and a right input image,
the plurality of output images comprise a leftmost view output image corresponding to the left input image and a rightmost view output image corresponding to the right input image,
the rightmost view output image is projected to a leftmost side of the plurality of output images whereas the leftmost view output image is projected to a rightmost side of the plurality of output images,
a right view output image among the plurality of output images is projected to a left eye of a viewer and a left view output image among the plurality of output images is projected to a right eye of the viewer when the viewer is located in one of the plurality of continuous spaces, the left view output image and the right view output image are images having neighboring views among the plurality of output images, a view of the left view output image is located on a left side of a view of the right view output image, and
the leftmost view output image is projected to the left eye of the viewer and the rightmost view output image is projected to the right eye of the viewer when the viewer is located in two of the plurality of continuous spaces.

19. The image processing apparatus of claim 16, wherein
the image outputter comprises a plurality of pixels, and
pixels corresponding to the plurality of output images are neighboring pixels among the plurality of pixels.

20. The image processing apparatus of claim 19, wherein
the image outputter further comprises a plurality of lenses,
lights emitted by the neighboring pixels are projected through a lens disposed in front of the neighboring pixels among the plurality of lenses, and
the lens projects the lights of the neighboring pixels in a direction opposite to a direction from a left to a right of the neighboring pixels.
